(19) United States
(12) Patent Application Publication
(10) Pub. No.: US 2023/0280170 A1
(43) Pub. Date: Sep. 7, 2023

(54) VEHICLE TRAVEL REQUEST DEVICE, VEHICLE TRAVEL REQUEST SYSTEM, AND VEHICLE TRAVEL REQUEST METHOD

(71) Applicant: TOYOTA JIDOSHA KABUSHIKI KAISHA, Aichi-ken (JP)

(72) Inventors: Takeo MORIAI, Nagakute-shi (JP); Masakazu SETOYAMA, Miyoshi-shi (JP); Teruo MORI, Ichinomiya-shi (JP); Takanobu HIRAKOSHI, Nagoya-shi (JP)

(21) Appl. No.: 18/146,467

(22) Filed: Dec. 27, 2022

(30) Foreign Application Priority Data
Mar. 1, 2022 (JP) 2022-031046

(51) Int. Cl. G01C 21/34

(52) U.S. Cl. CPC G01C 21/3438; G01C 21/3461; G01C 21/3492

(57) ABSTRACT

The vehicle travel request device includes a processor. The processor is configured to acquire travel request information related to a travel request of a vehicle, and transmit the travel request information to the vehicle based on the acquired information. Further, the processor is configured to acquire travel history information of the vehicle and determine an incentive based on the travel request information and the travel history information.

### CROSS-REFERENCE TO RELATED APPLICATION

This application claims priority to Japanese Patent Application No. 2022-031046 filed on Mar. 1, 2022, incorporated herein by reference in its entirety.

### BACKGROUND

### 1. Technical Field

The present disclosure relates to a vehicle travel request device, a vehicle travel request system, and a vehicle travel request method.

### 2. Description of Related Art

Japanese Unexamined Patent Application Publication No. 2016-95172 (JP 2016-95172 A) discloses a security support device that preferentially presents a road having a small traffic amount among a walking route from a current position of a user to a destination. Specifically, in the security support device of JP 2016-95172 A, a route with little pedestrian traffic is presented as a route by making it difficult to search for a route including a route through which another user has passed within a predetermined time.

### SUMMARY

However, with the security support device of JP 2016-95172 A, there is a possibility of being involved in a crime because it proposes a road where there is little pedestrian traffic. Thus, there is room for improvement in dispelling the uneasiness of a pedestrian walking on a road where there is little pedestrian traffic.

An object of the present disclosure is to provide a vehicle travel request device, a vehicle travel request system, and a vehicle travel request method capable of dispelling the uneasiness of a pedestrian walking on a road where there is little pedestrian traffic.

A vehicle travel request device according to a first aspect of the present disclosure includes a processor.

The processor is configured to: acquire travel request information related to a travel request of a vehicle; transmit travel request information to the vehicle based on acquired information; acquire travel history information of the vehicle; and determine an incentive based on the travel request information and the travel history information.

According to such a configuration, the processor acquires the travel request information and transmits the travel request information to the vehicle and thus, the vehicle is notified of the travel request information. Further, the processor acquires the travel history information of the vehicle, and determines an incentive based on the travel history information. Accordingly, in the case where the user is a pedestrian, a traffic amount can be temporarily increased by requesting the vehicle to travel when the user is walking on a road with little pedestrian traffic. Further, it is possible to determine the incentive after confirming that traveling has been performed as requested based on the traveling history. Here, the “travel history information” is not limited to the information on the travel route, and is a concept broadly including information on the process executed by the vehicle during travel.

In the vehicle travel request device according to the first aspect, the processor may be configured to transmit, as the travel request information, information including a travel section and a travel time, to the vehicle.

According to this configuration, since the travel section and the travel time are transmitted to the vehicle, the travel section and the travel time can be easily confirmed while the driver is traveling.

A vehicle travel request system according to a second aspect of the present disclosure includes: a vehicle provided with a display unit on an outer surface; and the vehicle travel request device according to above.

According to such a configuration, since the display unit is provided on the outer surface of the vehicle, the surroundings of the vehicle can be brightened by the display unit.

In the vehicle travel request system according to the second aspect, the travel request information may include an image to be displayed on the display unit.

According to such a configuration, the user can display an arbitrary image on the display unit of the vehicle. Thus, in addition to an effect of security, the user can enjoy viewing the image displayed on the display unit. Here, the “image” is not limited to a still image, but is a concept broadly including a video such as a movie or a television program.

A vehicle travel request method according to a third aspect of the present disclosure includes: acquiring travel request information related to a vehicle travel request; transmitting the travel request information to the vehicle based on acquired information; acquiring travel history information of the vehicle; and determining an incentive based on the travel request information and the travel history information.

As described above, with the vehicle travel request device, the vehicle travel request system, the vehicle travel request method, and the non-temporary storage medium according to the present disclosure, it is possible to dispelling the uneasiness of a pedestrian walking on a road with little pedestrian traffic.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an overall configuration of a system according to an embodiment;

FIG. 2 is a block diagram illustrating a hardware configuration of the vehicle travel request device according to the embodiment;

FIG. 3 is a block diagram illustrating a hardware configuration of a vehicle according to the embodiment;

FIG. 4 is a block diagram illustrating a functional configuration of the vehicle travel request device according to the embodiment;

FIG. 5 is a sequence diagram illustrating a flow of processing in the vehicle travel request system according to the embodiment.

### DETAILED DESCRIPTION OF EMBODIMENTS

The vehicle travel request system S including the vehicle travel request device 10 according to the embodiment will be described with reference to the drawings.

### Overall Structure

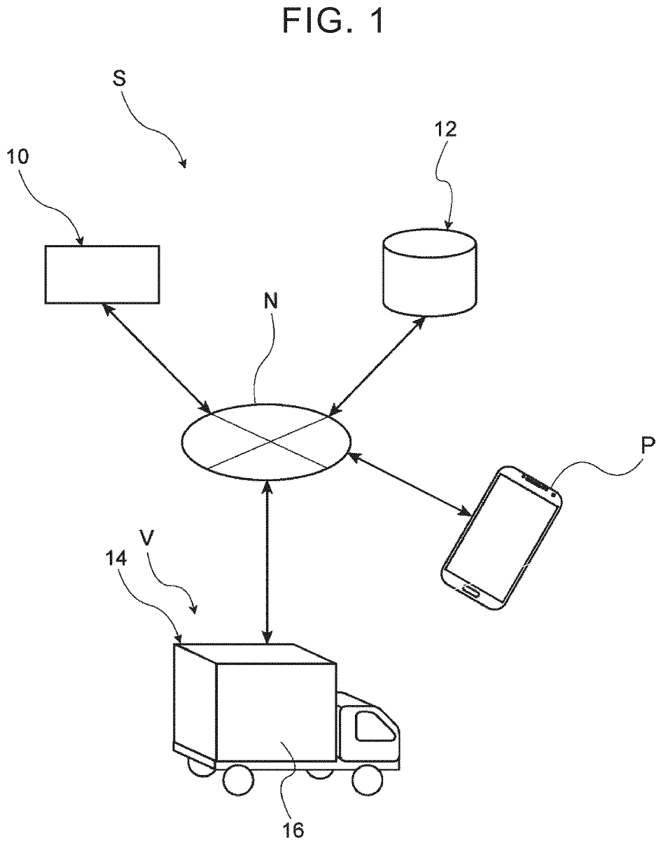

As illustrated in FIG. 1, the vehicle travel request system S includes a vehicle travel request device 10, a server 12, a vehicle V, and a portable terminal P. In addition, the vehicle travel request device 10, the server 12, and the vehicle V can communicate with each other via the network N. Note that, although one vehicle V is illustrated as an example in FIG. 1, the present disclosure is not limited to this, and a vehicle travel request system S including a plurality of vehicles V may be configured. Although only one mobile terminal P is illustrated as an example in FIG. 1, the vehicle travel request system S is actually configured to include mobile terminals of all users who use the vehicle travel request system S. Here, the “user” refers to a requester who uses the vehicle travel request device 10.

A storage area (not shown) is provided in the server 12, and various data are stored in the storage area. For example, the server 12 is configured to store data of advertisement information for display on the vehicle V, data of travel history information output from the vehicle V, and the like. Further, the server 12 stores travel request information received from the user via the portable terminal P. The travel request information includes a type of the vehicle, a travel time, a travel section, and user information. In the case of a vehicle in which the display unit 16 is provided on the outer surface, such as the vehicle V, the travel request information includes image information to be displayed on the display unit 16.

The display unit 16 of the vehicle V is provided on both sides in the vehicle width direction in the loading platform portion of the vehicle main body 14 and a surface on the vehicle rear side, and is a display area capable of displaying advertisement information.

The vehicle travel request system S is configured as described above, and the vehicle travel request device 10 according to the present embodiment is configured to acquire travel request information from the server 12 and transmit the travel request information to the vehicle V. Further, the vehicle travel request device 10 according to the present embodiment is configured to acquire travel history information of the vehicle V that has traveled in response to the travel request from the server 12, and determine an incentive based on the travel history information.

### (Hardware Configuration of the Vehicle Travel Request Device 10)

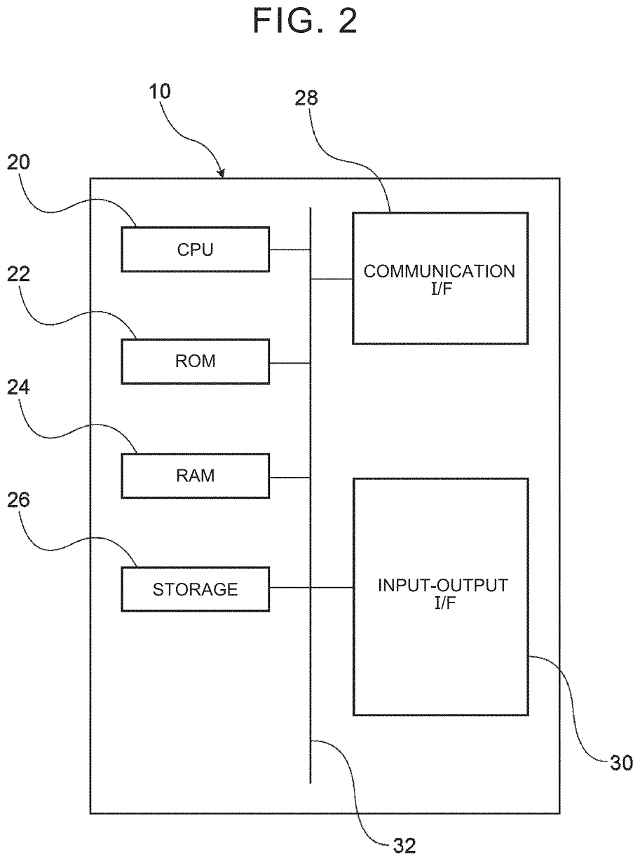

FIG. 2 is a block diagram illustrating a hardware configuration of a vehicle travel request device. As illustrated in FIG. 2, the vehicle travel request device 10 includes a Central Processing Unit (CPU (processor)) 20, a Read Only Memory (ROM) 22, Random Access Memory (RAM) 24, a storage 26, and a communication interface (including a communication I/F) 28 and an input/output interface (an input/output I/F) 30). Each configuration is communicably connected to each other via a bus 32.

CPU 20 is a central processing unit that executes various programs and controls each unit. That is, CPU 20 reads the program from ROM 22 or the storage 26, and executes the program using RAM 24 as a working area. In addition, CPU 20 performs control of the above-described configurations and various arithmetic processes in accordance with programs recorded in ROM 22 or the storage 26.

ROM 22 stores various programs and various data. RAM 24 is a non-transitory recording medium that temporarily stores programs/data as a working area. The storage 26 is a non-transitory recording medium configured by Hard Disk Drive (HDD) or Solid State Drive (SSD) and storing various programs including an operating system and various types of data. In the present embodiment, the storage 26 stores a program for executing a travel request process, various data, and the like.

The communication I/F 28 is an interface for the vehicle travel request device 10 to communicate with other devices such as the server 12 and the portable terminal P, and standards such as Controller Area Network (CAN, Ethernet (registered trademark), Long Term Evolution (LTE, Fiber Distributed Data Interface (FDDI, and Wi-Fi (registered trademark) are used.

The input/output I/F 30 is an interface through which the vehicle travel request device 10 performs input/output with the surrounding devices.

### (Hardware Configuration of Vehicle V)

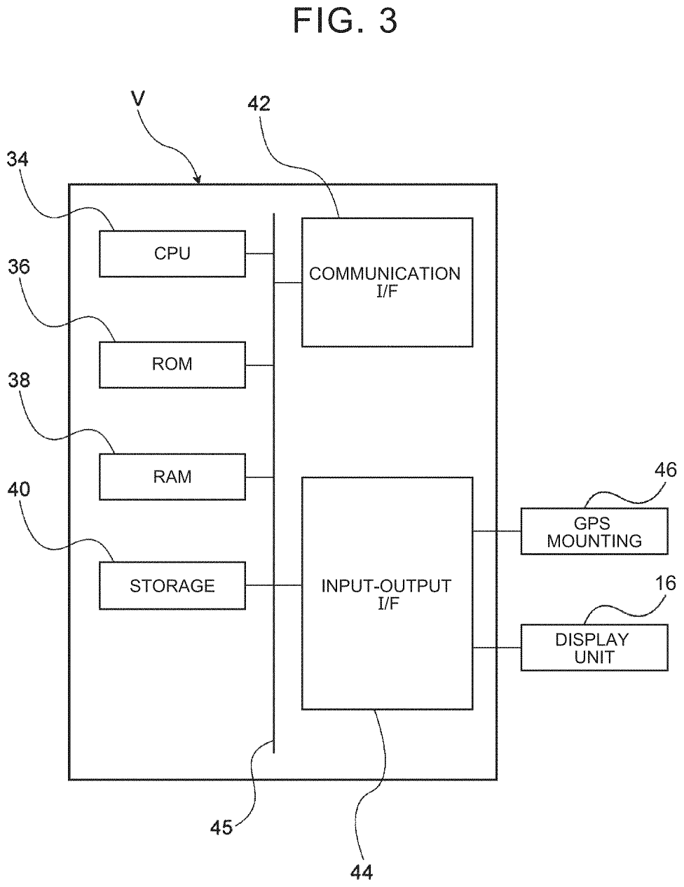

FIG. 3 is a block diagram illustrating a hardware configuration of the vehicle V. As illustrated in FIG. 3, the vehicle V includes a Central Processing Unit (CPU (processor) 34, a Read Only Memory (ROM) 36, Random Access Memory (RAM) 38, a storage 40, and a communication interface (including a communication I/F) 42 and an input/output interface (an input/output I/F) 44). The components are communicably connected to each other via a bus 45.

CPU 34 is a central processing unit that executes various programs and controls each unit. That is, CPU 34 reads the program from ROM 36 or the storage 40, and executes the program using RAM 38 as a working area. In addition, CPU 34 performs control of the above-described configurations and various arithmetic processes in accordance with programs recorded in ROM 36 or the storage 40.

ROM 36 stores various programs and various data. RAM 38 is a non-transitory recording medium that temporarily stores programs/data as a working area. The storage 40 is a non-transitory recording medium configured by Hard Disk Drive (HDD) or Solid State Drive (SSD) and storing various programs including an operating system and various types of data. In the present embodiment, the storage 40 stores advertisement information, travel request information, and the like downloaded from the server 12.

The communication I/F 42 is an interface for the vehicle V to communicate with the vehicle travel request device 10, the servers 12, and other devices, and standards such as Controller Area Network (CAN, Ethernet (Long Term Evolution (LTE), Fiber Distributed Data Interface (FDDI, and Wi-Fi (registered trademark) are used.

The input/output OF 30 is electrically connected to a Global Positioning System (GPS) device 46 and a display unit 16.

GPS device 46 receives GPS signals from a plurality of GPS satellites to determine the present position of the vehicles V.

As described above, the display unit 16 is provided on both sides of the vehicle main body 14 in the vehicle widthwise direction, and includes a liquid crystal display, an organic Electro-Luminescence (organic EL) display, and the like.

Here, in the present embodiment, as an example, advertisement information is normally displayed on the display unit 16. The display unit 16 is configured to display an arbitrary image designated by the user. For example, a movie designated by the user and a movie such as a television program are displayed on the display unit 16. Further, for example, the display unit 16 is configured to display an image created by the user himself/herself. (Functional Configuration of the vehicle travel request Device 10)

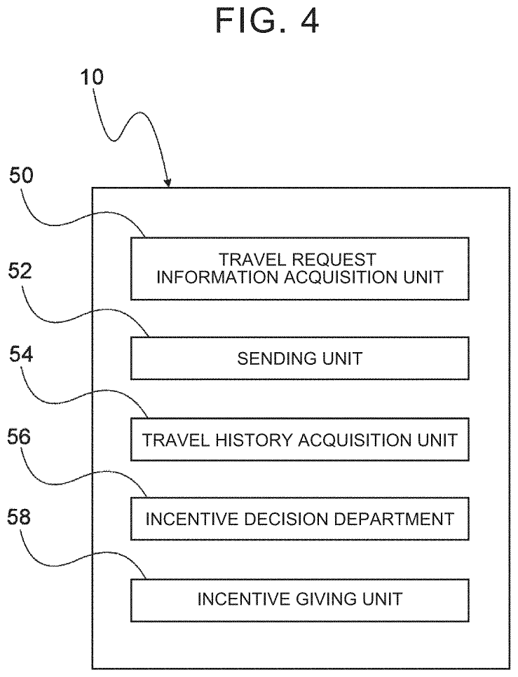

The vehicle travel request device 10 realizes various functions using the hardware resources illustrated in FIG. 2. A functional configuration realized by the vehicle travel request device 10 will be described with reference to FIG. 4.

As illustrated in FIG. 4, the vehicle travel request device 10 includes, as functional components, a travel request information acquisition unit 50, a transmission unit 52, a travel history acquisition unit 54, an incentive determination unit 56, and an incentive granting unit 58. The respective functional configurations are realized by CPU 20 reading and executing a program stored in ROM 22 or the storage 26.

The travel request information acquisition unit 50 acquires travel request information that is information related to a travel request of the vehicle. Specifically, the travel request information when the user makes a travel request for the vehicle from the portable terminal P is stored in the server 12. Then, the travel request information acquisition unit 50 acquires the travel request information stored in the server 12.

The travel request information input by the user includes information on the type of the vehicle, the travel time, the travel section, and an image to be displayed on the display unit 16. The type of the vehicle is not limited to the vehicle V provided with the display unit 16 on the outer surface, and includes a general passenger car. In addition, a vehicle including a speaker capable of outputting sound around the vehicle may be included.

The transmission unit 52 transmits the travel request information to the vehicle V based on the information acquired by the travel request information acquisition unit 50. Specifically, the vehicle travel request device 10 selects a vehicle that can travel on the basis of the requested travel time and the information on the travel section before the travel request information is transmitted by the function of the transmission unit 52. Each vehicle periodically transmits the current position determined by GPS device 46 to the server 12, and the vehicle travel request device 10 acquires the current position of each vehicle from the server 12 to select a vehicle that can travel in the travel section at the requested travel time.

When the type of the vehicle is included in the travel request information, the transmission unit 52 transmits the travel request information to the vehicle of the designated type. The vehicle V that has received the travel request information notifies the driver of the vehicle V that the travel request information has been received. Further, the vehicle V inquires of the driver about whether or not to accept the travel request. When the vehicle V is an autonomous vehicle that does not require a driver, the vehicle V may notify the management company or the like that the travel request information has been received.

When receiving a signal indicating that the travel request is accepted from the driver or the management company, the vehicle V transmits a signal indicating that the travel request is accepted from the vehicle V to the vehicle travel request device 10. Further, the travel time and the travel section may be set in the navigation system of the vehicle V.

Here, in a case where the travel time is long with respect to the travel section, that is, in a case where the vehicle V does not reach the requested travel time even if the vehicle V travels in the travel section at a normal speed equal to or lower than the legal speed, the navigation system may set the route so as to reciprocate or circulate the travel section.

When image information is included in the travel request information, the transmission unit 52 transmits image information to be displayed on the display unit 16 to the vehicle V. For example, when the image information to be displayed on the display unit 16 is a movie or the like, the transmission unit 52 transmits the access code of the storage unit in which the data of the designated movie is stored. When the image information to be displayed on the display unit 16 is a user's own image or the like, the transmission unit 52 may transmit the information of the address indicating the location where the data of the image is stored to the vehicle V.

The travel history acquisition unit 54 acquires travel history information obtained from the current position information of each vehicle V accumulated in the server 12. Specifically, since the signal from GPS device 46 is periodically transmitted from the vehicle V to the server 12, the travel route of the vehicle is obtained from the change in the present position of the vehicle V. When the data of the travel route is stored in the server 12, the travel history acquisition unit 54 acquires the data of the travel route of each vehicle V from the server 12 as travel history information. In a case where the data of the travel route is not stored in the server 12, the travel history acquisition unit 54 may acquire the travel route by calculating the travel route based on the position information of the vehicle V acquired from the server 12. Further, in addition to the travel route, the travel history acquisition unit 54 of the present embodiment acquires, as travel history information, information on an image displayed on the display unit 16 of the vehicle V, a time when the image is displayed on the display unit 16, and the like.

The incentive determination unit 56 acquires travel history information of the vehicle V, and determines an incentive based on the travel request information and the travel history information. For example, the incentive determination unit 56 calculates the incentive to increase as the traveling time increases. In addition, the incentive determination unit 56 calculates the incentive so that the incentive increases as the travel section becomes longer. Further, the incentive determination unit 56 calculates the incentive of the vehicle V including the display unit 16 to be larger than that of a general passenger vehicle.

The incentive granting unit 58 grants the incentive determined by the incentive determining unit 56 to the granting target. The type of the incentive and the method of giving the incentive are determined in advance with the driver of the vehicle V. When the driver of the vehicle V is the owner of the vehicle V or the user of the vehicle V, the grant target to which the incentive is given is the driver. When the driver of the vehicle V is an employee of a company holding the vehicle V or the like, the granted object to which the incentive is given is the company.

The type of incentive is not limited to money, and may be a virtual currency, a point, or the like. In addition, when the driver is driving the vehicle V with a service such as a sharing service and a subscription service, the usage fee of the vehicle V may be discounted by the incentive providing unit 58.

### Effect

Next, the effect of the present embodiment will be described.

### Example of Processing

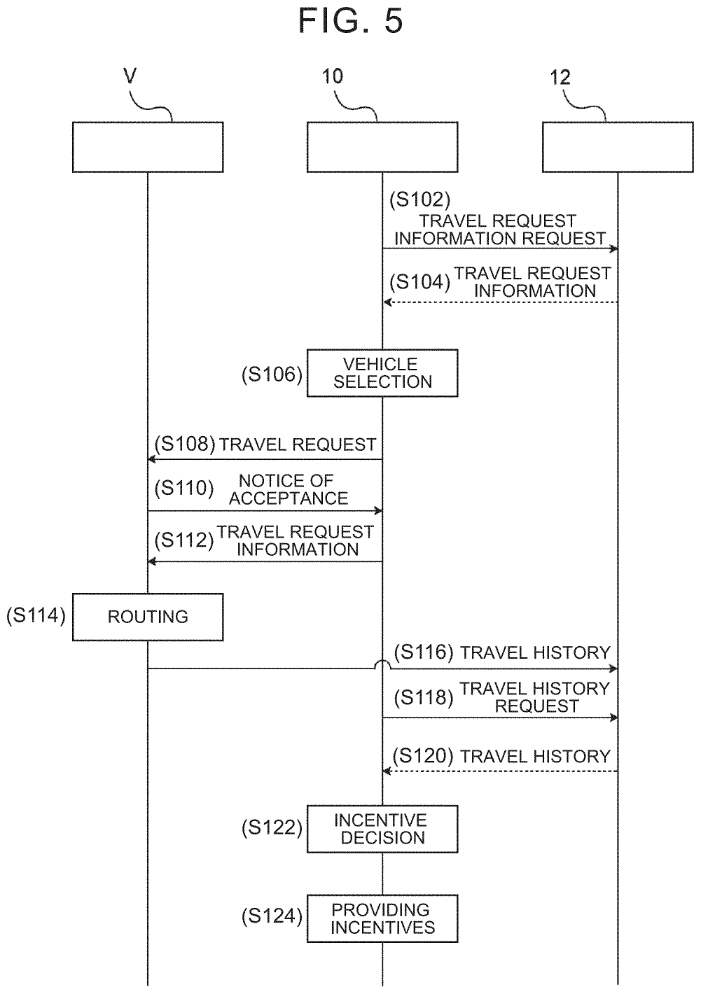

FIG. 5 is a sequence diagram illustrating an example of a flow of processing by the vehicle travel request system S according to the present embodiment, and is a diagram describing the vehicle V, the vehicle travel request device 10, and the server 12. The process performed by the vehicle travel request device 10 is executed by CPU 20 reading the program from ROM 22 or the storage 26 and expanding the program in RAM 24. Further, the process performed by the vehicles V is executed by CPU 34 reading the program from ROM 36 or the storage 40 and expanding the program in RAM 38.

As illustrated in FIG. 5, in the step S102, the vehicle travel request device 10 requests the server 12 for travel request information by the function of the travel request information acquiring unit 50. In the present embodiment, as an example, a travel request is made from the user to the vehicle travel request device 10, and the travel request information is stored in the server 12.

Note that the travel request from the user may be accumulated in the server 12. In this case, the vehicle travel request device 10 periodically checks the presence or absence of a travel request to the server 12. When a new travel request is confirmed, the vehicle travel request device 10 may request the server 12 for travel request information.

In the step S104, the travel request information is transmitted from the server 12 to the vehicle travel request device 10. As described above, the travel request information includes information such as a type of the vehicle, a travel time, a travel section, and an image to be displayed on the display unit 16.

In the step S106, the vehicle travel request device 10 selects a vehicle for which a travel request is made. Specifically, the vehicle travel request device 10 selects a vehicle that satisfies the condition included in the travel request information. For example, the vehicle travel request device 10 selects a vehicle that can arrive in the travel section by the travel time from among the vehicles that can make the travel request. When the type of the vehicle is included in the travel request information, the vehicle travel request device 10 selects the designated vehicle type.

In the step S108, the vehicle travel request device 10 requests the vehicle V selected in the step S106 to travel. When receiving the travel request, the vehicle V notifies the driver of the vehicle V that the travel request information has been received. For example, the vehicle V displays the travel request information on a display or the like provided in the vehicle cabin. Here, the vehicle V may display only simple information of only the travel time and the travel section.

In a case where the driver is not driving the vehicle V, that is, in a state where the vehicle V is powered off, the vehicle V may transmit the travel request information to the portable terminal or the like of the driver. In this way, an inquiry is made as to whether or not to accept a travel request from the vehicle V to the driver.

When the driver accepts the travel request, an acceptance notification is transmitted from the vehicle V to the vehicle travel request device 10 at step S110. The acceptance notification may be directly transmitted from the portable terminal or the like of the driver to the vehicle travel request device 10.

When the driver rejects the travel request, a rejection notification is transmitted from the vehicle V or the portable terminal of the driver to the vehicle travel request device 10. In this case, although not illustrated in FIG. 5, the vehicle travel request device 10 selects another vehicle and requests travel.

Upon receiving the commission notification, the vehicle travel request device 10 transmits the travel request information to the vehicle V by the function of the transmitting unit 52 in a step S112. Here, all information necessary for traveling is transmitted. For example, in addition to the travel time and the travel section, image information or the like to be displayed on the display unit 16 is transmitted.

The vehicle V that has acquired the travel request information in the step S112 sets the travel route by the navigation system mounted in the step S114. At this time, the vehicle V may set the travel start time to the navigation system.

In the step S116, the travel history information is transmitted from the vehicles V to the servers 12. Specifically, the present position of the vehicle V determined by GPS device 46 of the vehicle V is periodically transmitted to the servers 12. Note that the travel history information may be periodically transmitted from the vehicle V to the server 12 regardless of whether or not a travel request is made. Further, the transmission of the travel history information may be started from the vehicle V to the server 12 at the time when the travel start time of the travel request information is reached.

In the step S118, the travel history acquiring unit 54 requests the travel history information from the vehicle travel request device 10 to the server 12. In the present embodiment, as an example, the travel history acquisition unit 54 requests the server 12 for travel history information by the vehicle travel request device 10 in a state in which the travel end time of the travel request information has elapsed.

In the step S120, the information on the travel history information is transmitted from the server 12 to the vehicle travel request device 10. The travel history information transmitted from the server 12 to the vehicle travel request device 10 may be, for example, position information of the vehicle V acquired from the vehicle V at predetermined time intervals. In this case, the vehicle travel request device 10 calculates the travel route of the vehicle V based on the position information of the vehicle V received from the server 12.

Further, the travel history information transmitted from the server 12 to the vehicle travel request device 10 includes information on an image displayed on the display unit 16 of the vehicle V and information on a time when an image is displayed on the display unit 16. Thus, it is possible to confirm whether or not the correct image is displayed on the display unit 16 during the traveling time of the traveling request information.

In the step S122, the vehicle travel request device 10 determines an incentive by the function of the incentive determining unit 56. Specifically, the incentive determination unit 56 determines an incentive based on the travel request information and the travel history information. For example, when the vehicle V is traveling outside the travel section designated as the travel request information, the incentive determination unit 56 decreases the incentive. Further, for example, in a case where the information of the image displayed on the display unit 16 is different, and in a case where the image is displayed on the display unit 16 only for a part of the traveling time, the incentive determination unit 56 decreases the incentive. Further, when it is found from the travel history information that the vehicle V has violated the speed exceeding or the like, the incentive may be reduced by the incentive determining unit 56.

In the step S124, an incentive is given to the driver of the vehicle V from the vehicle travel request device 10 by the function of the incentive giving unit 58.

As described above, the vehicle travel request device 10 according to the present embodiment can notify the driver of the vehicle of the travel request information by acquiring the travel request information and transmitting it to the vehicle V. Further, the vehicle travel request device 10 acquires travel history information of the vehicle V, and gives an incentive to the driver of the vehicle V based on the travel history information. As a result, the user who is a pedestrian can request the vehicle V to travel when walking on a road with little traffic, and can temporarily increase the amount of traffic.

Further, in the present embodiment, the vehicle travel request device 10 can give an incentive after confirming that the vehicle has traveled as requested based on the travel history.

Further, in the present embodiment, since the travel section and the travel time are transmitted to the vehicle V as the traveling request information, it is possible to suppress the driver from traveling the vehicle in the wrong travel section and the travel time. In particular, when the travel time and the travel route are set by a navigation system or the like mounted on the vehicle V as in the present embodiment, the driver can travel on the requested road without paying special attention.

Further, in the present embodiment, since the display unit 16 is provided on the outer surface of the vehicle V, the surroundings of the vehicle V can be brightened by the display unit 16. Further, since the user can display an arbitrary image on the display unit 16 of the vehicle V, the user can enjoy viewing the image displayed on the display unit 16 in addition to the effect of security.

When a movie, a television program, or the like is displayed on the display unit 16, the voice data may be wirelessly transmitted from the vehicle V to a device such as an earphone possessed by the user. Accordingly, the user can enjoy a movie, a television program, and the like while listening to sound. In addition, since no sound is generated directly from the vehicle V, it is possible to suppress the generation of noise even when the road on which the vehicle V is traveling is a quiet place.

Further, in the present embodiment, the vehicle travel request device 10 can be used by a user to show an image to a specific person. That is, an image prepared in advance by the user is displayed on the display unit 16 of the vehicle V, and the travel section of the vehicle V is set to a place where a specific person is present, so that an arbitrary image can be shown to a specific person in a public place.

Although the vehicle travel request device 10 according to the embodiment has been described above, it is needless to say that the vehicle travel request device can be implemented in various forms without departing from the gist of the present disclosure. For example, in the above embodiment, the configuration in which the vehicle travel request device 10 is provided outside the vehicle V has been described, but the present disclosure is not limited thereto, and the vehicle travel request device 10 may be mounted on the vehicle V.

Further, in the above embodiment, the configuration in which the display unit 16 is provided in the vehicle V has been described, but the present disclosure is not limited thereto. That is, a travel request may be made to a passenger car that does not include the display unit 16.

Further, in the above embodiment, the configuration in which the driver drives the vehicle V has been described, but the present disclosure is not limited thereto. For example, a configuration may be adopted in which a travel request is made to the autonomous vehicle. In this case, the incentive is given to a company or the like that owns the autonomous vehicle.

Furthermore, a process executed by CPU20 reading the program in the above-described embodiment may be executed by various processors other than CPU20. Examples of the processor include a Programmable Logic Device (PLD in which a circuit configuration can be changed after manufacturing of Field-Programmable Gate Array (FPGA, and the like, and a dedicated electric circuit that is a processor having a circuit configuration designed exclusively for executing a particular process such as Application Specific Integrated Circuit (ASIC, and the like. In addition, each process may be executed by one of these various processors, or may be executed by a combination of two or more processors of the same kind or different kinds. For example, the processes may be executed by a plurality of FPGAs, a combination of the CPU and the FPGA, and the like. The hardware structure of these various processors is, more specifically, an electric circuit in which circuit elements such as semiconductor elements are combined.

In the above-described embodiment, the programs are stored (installed) in advance in a non-transitory computer-readable recording medium, but the present disclosure is not limited thereto, and the programs may be provided in a form recorded in a non-transitory recording medium such as Compact Disc Read Only Memory (CD-ROM), Digital Versatile Disc Read Only Memory (DVD-ROM), and Universal Serial Bus (USB). Further, the program may be downloaded from an external device via a network.

Further, the flow of the processing described in the above embodiment is an example, and unnecessary steps may be deleted, new steps may be added, or the processing order may be changed within a range not departing from the gist.

What is claimed is:

1. A vehicle travel request device comprising a processor,
wherein the processor is configured to:
acquire travel request information related to a travel request of a vehicle;
transmit the travel request information to the vehicle based on acquired information;
acquire travel history information of the vehicle; and
determine an incentive based on the travel request information and the travel history information.

2. The vehicle travel request device according to claim 1, wherein the processor is configured to transmit information including a travel section and a travel time, as the travel request information, to the vehicle.

3. A vehicle travel request system comprising:
a vehicle with a display unit provided on an outer surface; and
the vehicle travel request device according to claim 1.

4. The vehicle travel request system according to claim 3, wherein the travel request information includes an image to be displayed on the display unit.

5. A vehicle travel request method comprising:
acquiring travel request information related to a travel request of a vehicle;
transmitting the travel request information to the vehicle based on acquired information;
acquiring travel history information of the vehicle; and
determining an incentive based on the travel request information and the travel history information.
